(19) United States
(12) Patent Application Publication
(10) Pub. No.: US 2017/0135132 A1
(43) Pub. Date: May 11, 2017

(54) METHOD, SYSTEM AND APPARATUS

(71) Applicant: Nokia Solutions and Networks Oy, Espoo (FI)

(72) Inventor: Srinivasan Selvaganapathy, Bangalore (IN)

(21) Appl. No.: 15/332,341

(22) Filed: Oct. 24, 2016

(30) Foreign Application Priority Data
Nov. 6, 2015 (IN) 3629/DEL/2015

(51) Int. Cl. H04W 74/08; H04W 74/00

(52) U.S. Cl. CPC H04W 74/085; H04W 74/004; H04W 74/006

(57) ABSTRACT

A method comprises causing random access channel preamble information to be sent from a device to an access point, said random access channel preamble information being usable by said access point to determine first timing advance information; and receiving in response to said random access channel preamble information, timing information indicating if said first timing advance information is to be used for transmissions from said device to said access point.

### FIELD

The present application relates to a method, apparatus, system and computer program and in particular but not exclusively providing a random access procedure.

### BACKGROUND

A communication system can be seen as a facility that enables communication sessions between two or more entities such as user terminals, base stations and/or other nodes by providing carriers between the various entities involved in the communications path. A communication system can be provided for example by means of a communication network and one or more compatible communication devices. The communication sessions may comprise, for example, communication of data for carrying communications such as voice, electronic mail (email), text message, multimedia and/or content data and so on. Non-limiting examples of services provided comprise two-way or multi-way calls, data communication or multimedia services, machine type communications and access to a data network system, such as the Internet.

In a wireless communication system at least a part of a communication session between at least two stations occurs over a wireless link Examples of wireless systems comprise public land mobile networks (PLMN), satellite based communication systems and different wireless local networks, for example wireless local area networks (WLAN). The wireless systems can typically be divided into cells, and are therefore often referred to as cellular systems.

A user can access the communication system by means of an appropriate communication device or terminal. A communication device of a user is often referred to as user equipment (UE). A communication device is provided with an appropriate signal receiving and transmitting apparatus for enabling communications, for example enabling access to a communication network or communications directly with other users. The communication device may access a carrier provided by a station, for example a base station of a cell, and transmit and/or receive communications on the carrier.

The communication system and associated devices typically operate in accordance with a given standard or specification which sets out what the various entities associated with the system are permitted to do and how that should be achieved. Communication protocols and/or parameters which shall be used for the connection are also typically defined.

### SUMMARY

According to an aspect, there is provided a method comprising: causing random access channel preamble information to be sent from a device to an access point, said random access channel preamble information being usable by said access point to determine first timing advance information; and receiving in response to said random access channel preamble information, timing information indicating if said first timing advance information is to be used for transmissions from said device to said access point.

The timing information may be in a control channel or a random access response.

The channel may be a packet data control channel.

The timing information may be provided by a downlink control indication.

If said timing information indicates that said timing information is not to be used, the method may comprise causing said device to use second timing advance information.

The second timing advance information may be provided by a downlink control indication in an assigned radio access identifier.

The timing information indicating that said timing information is not to be used may comprise a NACK.

The timing information indicating that said timing information is to be used may comprise an acknowledgement, and said acknowledgement causes said timing advance information to be used.

The timing information may comprise a bitmap of preambles, each bit indicating an acknowledgement of a respective preamble, said method may comprise using a dedicated resource implicitly mapped to a preamble used by said device, using the first timing advance information.

The timing information may comprise a list of preambles with respective acknowledgements or NACKs in a control channel.

The random access channel preamble information may comprise a random access channel preamble sent with a timing defined by the timing advance information.

The causing the random access preamble to be sent may comprise sending said random access channel preamble information in a dedicated resource.

This method may be performed in an apparatus. The apparatus may be provided in a communication device or a device with communication capabilities.

According to another aspect, there may be provided a method comprising: receiving, at an access point, random access channel preamble information from a device; determining from said random access channel preamble information timing information indicating if first timing advance information is to be used for transmissions from said device to said access point; and causing, in response to said random access channel preamble information, said timing information to be transmitted to said device.

The timing information may be in a control channel or a random access response.

The channel may be a packet data control channel.

The timing information may be provided by a downlink control indication.

If said timing information indicates that said timing information is not to be used, the method may comprise providing second timing advance information for said device.

The second timing advance information may be provided by a downlink control indication in an assigned radio access identifier.

The timing information indicating that said timing information is not to be used may comprises a NACK and said timing information indicating that said timing information is to be used may comprises an acknowledgement.

The timing information may comprise a bitmap of preambles, each bit indicating an acknowledgement of a respective preamble, said method may comprise using a dedicated resource implicitly mapped to a preamble used by said device, using the first timing advance information.

The timing information may comprise a list of preambles with respective acknowledgements or NACKs in a control channel.

The random access channel preamble information may comprise a random access channel preamble sent with a timing defined by the timing advance information.

The method may comprise receiving the random access preamble information in a dedicated resource.

The determining may comprise determining if said timing of said preamble falls within a duration.

The method may be performed in an apparatus. The apparatus may be in an access point such as a base station.

According to another aspect, there is provided an apparatus in a device comprising at least one processor and at least one memory including computer code for one or more programs, the at least one memory and the computer code configured, with the at least one processor, to cause the apparatus at least to: cause random access channel preamble information to be sent from a device to an access point, said random access channel preamble information being usable by said access point to determine first timing advance information; and receive in response to said random access channel preamble information, timing information indicating if said first timing advance information is to be used for transmissions from said device to said access point.

The timing information may be in a control channel or a random access response.

The channel may be a packet data control channel.

The timing information may be provided by a downlink control indication.

The at least one memory and the computer code may be configured, with the at least one processor, to cause the apparatus to, if said timing information indicates that said timing information is not to be used, use second timing advance.

The second timing advance information may be provided by a downlink control indication in an assigned radio access identifier.

The timing information indicating that said timing information is not to be used may comprise a NACK.

The timing information indicating that said timing information is to be used may comprise an acknowledgement, and the at least one memory and the computer code may be configured, with the at least one processor, to cause the apparatus to use said timing advance information.

The timing information may comprise a bitmap of preambles, each bit indicating an acknowledgement of a respective preamble, and the at least one memory and the computer code may be configured, with the at least one processor, to cause the apparatus to, use a dedicated resource implicitly mapped to a preamble used by said device, using the first timing advance information.

The timing information may comprise a list of preambles with respective acknowledgements or NACKs in a control channel.

The random access channel preamble information may comprise a random access channel preamble sent with a timing defined by the timing advance information.

The at least one memory and the computer code may be configured, with the at least one processor, to cause the apparatus to send said random access channel preamble information in a dedicated resource.

According to another aspect, there is provided an apparatus in an access point device comprising at least one processor and at least one memory including computer code for one or more programs, the at least one memory and the computer code configured, with the at least one processor, to cause the apparatus at least to: receive random access channel preamble information from a device; determine from said random access channel preamble information timing information indicating if first timing advance information is to be used for transmissions from said device to said access point; and causing, in response to said random access channel preamble information, said timing information to be transmitted to said device.

The timing information may be in a control channel or a random access response.

The channel may be a packet data control channel.

The timing information may be provided by a downlink control indication.

If said timing information indicates that said timing information is not to be used, the method may comprise providing second timing advance information for said device.

The second timing advance information may be provided by a downlink control indication in an assigned radio access identifier.

The timing information indicating that said timing information is not to be used may comprises a NACK and said timing information indicating that said timing information is to be used may comprises an acknowledgement.

The timing information may comprise a bitmap of preambles, each bit indicating an acknowledgement of a respective preamble, and the at least one memory and the computer code may be configured, with the at least one processor, to cause the apparatus to use a dedicated resource implicitly mapped to a preamble used by said device, using the first timing advance information.

The timing information may comprise a list of preambles with respective acknowledgements or NACKs in a control channel.

The random access channel preamble information may comprise a random access channel preamble sent with a timing defined by the timing advance information.

The at least one memory and the computer code may be configured, with the at least one processor, to cause the apparatus to receive the random access preamble information in a dedicated resource.

The at least one memory and the computer code may be configured, with the at least one processor, to cause the apparatus to determine if said timing of said preamble falls within a duration.

The apparatus may be provided in an access node. The access node may be a base station.

According to another aspect, there is provided an apparatus comprising: means for causing random access channel preamble information to be sent from a device to an access point, said random access channel preamble information being usable by said access point to determine first timing advance information; and means for receiving in response to said random access channel preamble information, timing information indicating if said first timing advance information is to be used for transmissions from said device to said access point.

The timing information may be in a control channel or a random access response.

The channel may be a packet data control channel.

The timing information may be provided by a downlink control indication.

If said timing information indicates that said timing information is not to be used, the apparatus may comprise means for causing said device to use second timing advance information provided in said control channel.

The second timing advance information may be provided by a downlink control indication in an assigned radio access identifier.

The timing information indicating that said timing information is not to be used may comprise a NACK.

The timing information indicating that said timing information is to be used may comprise an acknowledgement, and said apparatus may comprise means to causes said timing advance information to be used in response to said acknowledgement.

The timing information may comprise a bitmap of preambles, each bit indicating an acknowledgement of a respective preamble, said apparatus may comprise means for using a dedicated resource implicitly mapped to a preamble used by said device, using the first timing advance information.

The timing information may comprise a list of preambles with respective acknowledgements or NACKs in a control channel.

The means for causing random access channel preamble information to be sent may cause the random access channel preamble to be sent with a timing defined by the timing advance information.

The means for causing random access channel preamble information to be sent may cause the random access channel preamble to be sent in a dedicated resource.

The apparatus may be provided in a communication device or a device with communication capabilities or be a communication device.

According to another aspect, there may be provided an apparatus comprising: means for receiving, at an access point, random access channel preamble information from a device; means for determining from said random access channel preamble information timing information indicating if first timing advance information is to be used for transmissions from said device to said access point; and means for causing, in response to said random access channel preamble information, said timing information to be transmitted to said device.

The timing information may be in a control channel or a random access response.

The channel may be a packet data control channel.

The timing information may be provided by a downlink control indication.

If said timing information indicates that said timing information is not to be used, the method may comprise providing second timing advance information for said device.

The second timing advance information may be provided by a downlink control indication in an assigned radio access identifier.

The timing information indicating that said timing information is not to be used may comprises a NACK and said timing information indicating that said timing information is to be used may comprises an acknowledgement.

The timing information may comprise a bitmap of preambles, each bit indicating an acknowledgement of a respective preamble, said apparatus may comprise means for using a dedicated resource implicitly mapped to a preamble used by said device, using the first timing advance information.

The timing information may comprise a list of preambles with respective acknowledgements or NACKs in a control channel.

The random access channel preamble information may comprise a random access channel preamble sent with a timing defined by the timing advance information.

The receiving means may receive the random access preamble information in a dedicated resource.

The determining means may be for determining if said timing of said preamble falls within a duration.

The apparatus may be in an access point, such as a base station.

A computer program comprising program code means adapted to perform the methods may also be provided.

According to a further aspect there is provided a computer program product for a computer, comprising software code portions for performing the steps of the above methods when said product is run on the computer.

In the above, many different embodiments have been described. It should be appreciated that further embodiments may be provided by the combination of any two or more of the embodiments described above.

Various other aspects and further embodiments are also described in the following detailed description and in the attached claims.

### DESCRIPTION OF FIGURES

Embodiments will now be described, by way of example only, with reference to the accompanying Figures in which:

FIG. 1 shows a schematic diagram of an example communication system comprising a base station and a plurality of communication devices;

FIG. 2 shows a schematic diagram of an example mobile communication device;

FIG. 3 shows a schematic diagram of an example control apparatus;

FIG. 4 shows a RACH (random access channel) procedure;

FIG. 5 shows PRACH (packet RACH) slots and its repetition in an uplink frame structure;

FIG. 6 shows a signal flow between a communication device and an access node in an embodiment; and

FIG. 7 shows a method of an embodiment.

### DETAILED DESCRIPTION

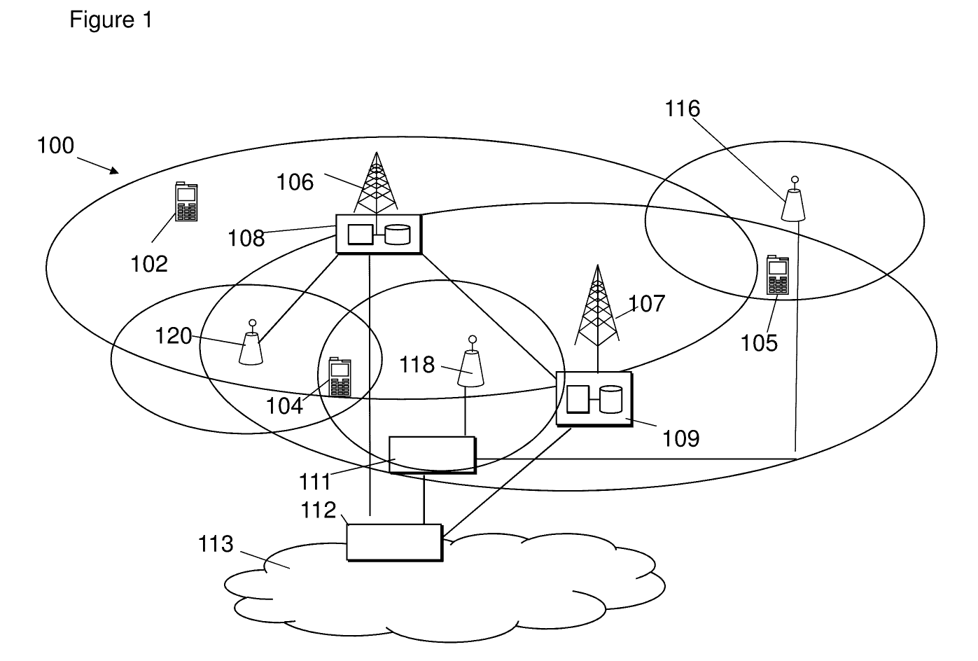

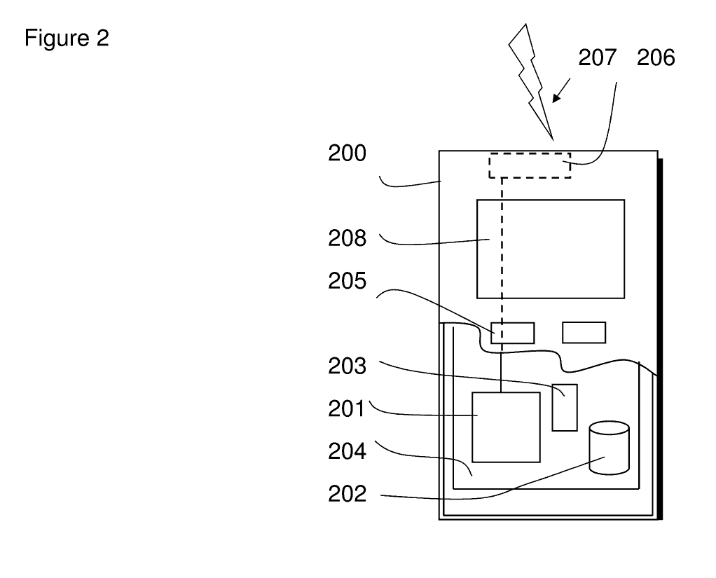

Before explaining in detail the examples, certain general principles of a wireless communication system and mobile communication devices are briefly explained with reference to FIGS. 1 to 2 to assist in understanding the technology underlying the described examples.

In a wireless communication system 100, such as that shown in FIG. 1, communication devices or user equipment (UE) 102, 104, 105 are provided wireless access via at least one base station or similar wireless transmitting and/or receiving node or point. Base stations are typically controlled by at least one appropriate controller apparatus, so as to enable operation thereof and management of mobile communication devices in communication with the base stations. The controller apparatus may be located in a radio access network (e.g. wireless communication system 100) or in a core network (CN) (not shown) and may be implemented as one central apparatus or its functionality may be distributed over several apparatus. The controller apparatus may be part of the base station and/or provided by a separate entity such as a Radio Network Controller. In FIG. 1 control apparatus 108 and 109 are shown to control the respective macro level base stations 106 and 107. The control apparatus of a base station can be interconnected with other control entities. The control apparatus is typically provided with memory capacity and at least one data processor. The control apparatus and functions may be distributed between a plurality of control units. In some systems, the control apparatus may additionally or alternatively be provided in a radio network controller.

LTE systems may however be considered to have a so-called “flat” architecture, without the provision of RNCs. Rather the (e)NB is in communication with a system architecture evolution gateway (SAE-GW) and a mobility management entity (MME), which entities may also be pooled meaning that a plurality of these nodes may serve a plurality (set) of (e)NBs. Each UE is served by only one MME and/or S-GW at a time and the (e) NB keeps track of current association. SAE-GW is a “high-level” user plane core network element in LTE, which may consist of the S-GW and the P-GW (serving gateway and packet data network gateway, respectively). The functionalities of the S-GW and P-GW are separated and they are not required to be co-located.

In FIG. 1 base stations 106 and 107 are shown as connected to a wider communications network 113 via gateway 112. A further gateway function may be provided to connect to another network.

The smaller base stations 116, 118 and 120 may also be connected to the network 113, for example by a separate gateway function and/or via the controllers of the macro level stations. The base stations 116, 118 and 120 may be pico or femto level base stations or the like. In the example, stations 116 and 118 are connected via a gateway 111 whilst station 120 connects via the controller apparatus 108. In some embodiments, the smaller stations may not be provided. Smaller base stations 116, 118 and 120 may be part of a second network, for example WLAN and may be WLAN APs.

A possible wireless communication device will now be described in more detail with reference to FIG. 2 showing a schematic, partially sectioned view of a communication device 200. An appropriate communication device may be provided by any device capable of sending and receiving radio signals. Non-limiting examples comprise a mobile station (MS) or mobile device such as a mobile phone or what is known as a ‘smart phone’, a computer provided with a wireless interface card or other wireless interface facility (e.g., USB dongle), personal data assistant (PDA) or a tablet provided with wireless communication capabilities, a device which makes machine type communications or any combinations of these or the like. A communication device may provide, for example, communication of data for carrying communications such as voice, electronic mail (email), text message, multimedia, data, and so on.

The communication device 200 may receive signals over an air or radio interface 207 via appropriate apparatus for receiving and may transmit signals via appropriate apparatus for transmitting radio signals. In FIG. 2 transceiver apparatus is designated schematically by block 206. The transceiver apparatus 206 may be provided for example by means of a radio part and associated antenna arrangement. The antenna arrangement may be arranged internally or externally to the mobile device.

A communication device is typically provided with at least one data processing entity 201, at least one memory 202 and other possible components 203 for use in software and hardware aided execution of tasks it is designed to perform, including control of access to and communications with access systems and other communication devices. The data processing, storage and other relevant control apparatus can be provided on an appropriate circuit board and/or in chipsets. This feature is denoted by reference 204. A user may control the operation of the device by means of a suitable user interface such as key pad 205, voice commands, touch sensitive screen or pad, combinations thereof or the like. One or more of a display 208, a speaker and/or a microphone can be also provided. Furthermore, a communication device may comprise appropriate connectors (either wired or wireless) to other devices and/or for connecting external accessories thereto.

The communication devices 102, 104, 105 may access the communication system based on various access techniques, such as code division multiple access (CDMA), or wideband CDMA (WCDMA). Other non-limiting examples comprise time division multiple access (TDMA), frequency division multiple access (FDMA) and various schemes thereof such as the interleaved frequency division multiple access (IFDMA), single carrier frequency division multiple access (SC-FDMA) and orthogonal frequency division multiple access (OFDMA), space division multiple access (SDMA) and so on.

An example of wireless communication systems are architectures standardized by the 3rd Generation Partnership Project (3GPP). A latest 3GPP based development is often referred to as the long term evolution (LTE) of the Universal Mobile Telecommunications System (UMTS) radio-access technology. The various development stages of the 3GPP specifications are referred to as releases.

Other examples of radio access system comprise those provided by base stations of systems that are based on technologies such as wireless local area network (WLAN) and/or WiMax (Worldwide Interoperability for Microwave Access).

Machine type communication is expected to rise. Various use cases and variants of machine type communication or IoT (Internet of things) have been proposed. For example, it has been proposed to deploy throughput devices in extended coverage conditions or in non-extended coverage conditions. Extended coverage is generally where the network conditions are relatively poor, for example due to distance from the access point and/or the location of the device. This may mean that to attach to the access point, a RACH procedure needs to be repeated several times.

These devices may be low cost and/or have low throughput. A low throughput device will not transmit or receive much data. For example, sensors or smart meters may be deployed in basement or indoor coverage conditions.

It has been proposed that some low throughput devices with extended coverage aim to provide one or more of the following:
20 dB additional MCL (minimum coupling loss) compared to GPRS (general packet radio service) coverage;
Extended battery life, for example up to 10 years; and
Lower complexity than GPRS devices with for example a minimum throughput of 160 bps at extreme coverage conditions.

These devices may be stationary or subject to low mobility conditions. One approach introduces NB-CIoT (narrow band-cellular internet of things). This proposal is based on narrowband OFDM in downlink and narrowband FDMA in uplink to achieve the target performance. Another solution for a narrowband IOT (internet of things) is based on a LTE concept adapted to 200 KHz is known as NB-LTE (narrow band-LTE).

In NB-LTE, the uplink uses SCFDMA (single carrier FDMA) with an OFDM structure of 72 carriers and subcarrier spacing of 2.5 KHz. With this, the uplink sub-frame length is extended to 6 ms and the frame length is extended to 60 ms. With this extended frame structure, the energy consumption for uplink may be higher compared to SC-FDMA operation in LTE. Some embodiments, aim to provide optimum uplink procedures for NB-LTE devices.

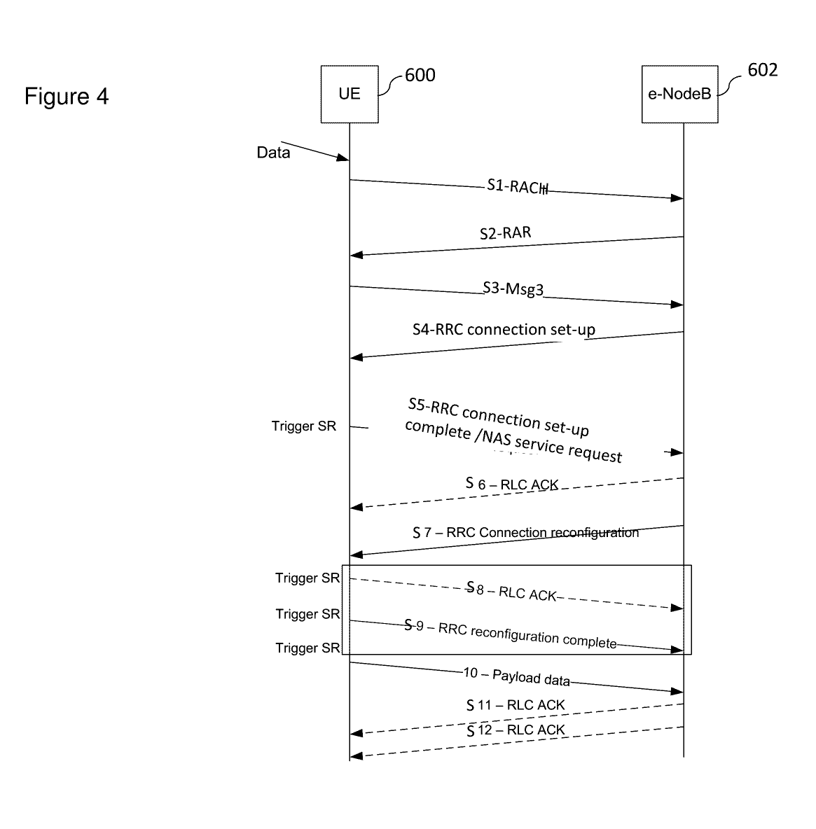

The RACH Access procedure in LTE will now be described with reference to FIG. 4. This Figure illustrates the steps involved in RACH Access.

In step S1, the UE selects one of the available RACH preambles which is transmitted from the UE 600 to the eNodeB 602. The preamble is sent with an RA-RNTI (random access-radio network temporary identifier). If the UE does not receive any response from the eNodeB, the UE will increase its power and retransmit the RACH preamble and RA-RNTI. (In poor network conditions, this step may need to be repeated several times)

In step S2, the eNodeB will, when it receives the UE transmission, transmit a RAR (random access response) via the PDCCH (physical downlink control channel) addressed to the RA-RNTI followed by PDSCH (physical downlink shared channel). The message will include a temporary C-RNTI (cell radio RNTI). The RAR will include an uplink grant resource and a timing advance value. The RAR step includes providing a PDCCH with a DCI (downlink control information) which includes information about the resource allocation in the PDSCH for the RAR and the PDSCH which carries the RAR. It is applicable for all downlink and uplink steps.

In step S3, the UE will transmit an Msg3 using the uplink allocations given in RAR. Msg3 is a radio resource connection RRC message such a RRC connection request. The message will comprise a UE identity such as a TMSI (temporary mobile subscriber identity) or random value.

In step S4, the eNodeB transmits a RRC-connection setup message. A contention resolution message Msg4 is transmitted by the eNodeB in downlink PDSCH (physical downlink shared channel) or based on the PDCCH and contains a C-RNTI which is used for further communication.

In step S5, the UE sends RRC connection complete message and a NAS (non access stratum) service request to the eNodeB.

In step S6, the eNodeB sends a RLC (radio link control) acknowledgment to the UE.

In step S7, the eNodeB sends an RRC reconnection configuration message to the UE.

In step S8, the UE sends a RLC (radio link control) acknowledgment to the eNodeB.

In step S9, the UE sends RRC connection complete message.

In step S10, payload data is transmitted by the UE to the eNodeB.

In steps S11 and S12, acknowledgements of the payload data is periodically sent.

It should be appreciated that one or more of steps S5, S8, and S9 may trigger a scheduling request SR. The SR is a request of scheduling radio resource for uplink transmission by the UE to the eNodeB. UE sends the SR on the PUCCH.

In LTE-M (LTE-machine for machine to machine communications), the RACH preambles are repeated a specific number of times depending on the coverage condition. For an extreme coverage condition, this could require 18 transmissions with 3 successive transmissions in 12 ms slots within a M-Frame continue for 6*M-Frames or 6*PRACH-Period. With PRACH-Period as 1 M-Frame, the maximum transmission would be 360 msecond. If a preamble transmitted by a device is not acknowledged, the preamble is transmitted again with a higher power. This is repeated until the maximum power is reached or a preamble transmission is acknowledged (ACKed) by the eNodeB. The PDCCH providing the control information for the PDSCH carrying the RAR and the PDSCH for carrying the RAR would require another 96 ms (PDCCH) and 360 ms (PDSCH). A M-Frame is the defined frame of the LTE-proposal.

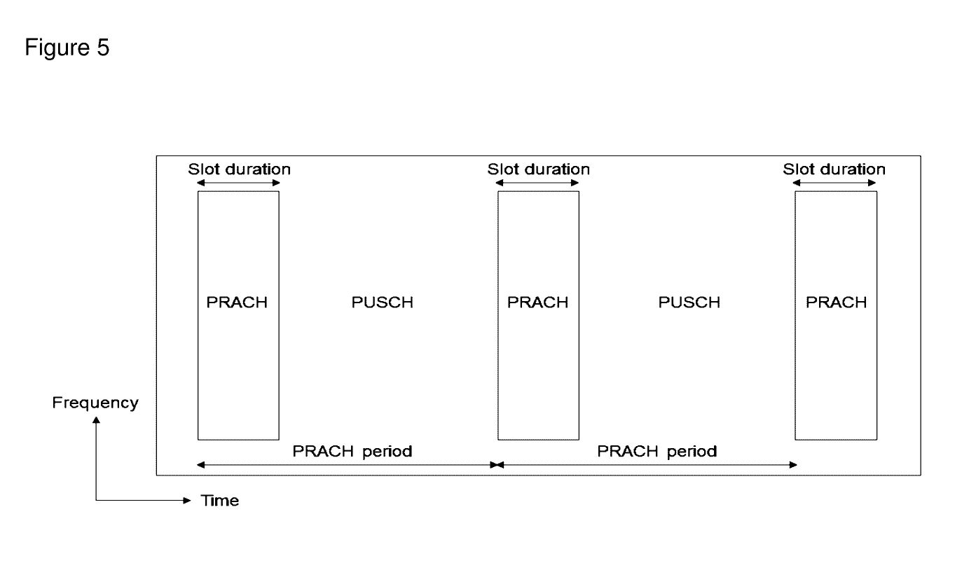

Reference is made to FIG. 5 which shows the PRACH Slots and its repetition in an uplink frame structure. With extension of PRBs (physical resource blocks) in the time domain in downlink and the reduced subcarrier spacing in uplink, the latency of RACH access procedure may be increased. This delay component will be a component in overall latency calculations for transmission of an exception report (for example alarms or warnings) in uplink.

The RACH procedure is to time-align different uplink users so that they can be multiplexed in orthogonal manner in uplink. The focus of CIoT-Low-complexity is mainly on stationary devices or limited mobility. Most of the devices will be installed within fixed equipment such as energy meters, vending machines or the like. In some embodiments, for such devices the timing advance assigned earlier can be stored and used in further access without need to get the timing advance from the network again.

In some embodiments, the random access procedure is modified such that the step where a device has to read the random access response (RAR) in the PDSCH is removed. All the information needed (msg2 feedback) for msg3 transmission is included in the PDCCH for devices with a valid TA (and C-RNTI) to have an implicit mapping from preambles to UL resources for Msg3. Information required by the device is included in the system information to reduce the number of steps for the RACH procedure.

As it is not necessary for the device to decode the RAR in the PDSCH, the device can start sending PUSCH (msg3) when it has received the PDCCH. By this a shortened time for UL data transmission for devices in poor coverage conditions is potentially achieved.

With the help of a downlink control format indication in PDCCH which can acknowledge the RACH preamble and implicitly assign the uplink resources, the RACH Access procedure is reduced by removing the step involving reading the PDSCH to receive the Random Access Response.

In some embodiments, the devices which have preserved timing advance are assigned with different RACH resources in terms of preambles or RACH time slots. This reservation is possible via system information configuration. A separate RACH resource can be used for devices with preserved timing advance. This is to isolate the RACH from these stationary devices and other devices.

A device with stored timing advance, may always attempt to send its preamble as per the stored timing advance.

The eNodeB will determine of the preserved timing advance or if a new timing advance needs to be used by the communication device. If a new TA value is required to be communicated, the DCI of some embodiments will indicate a NACK and redirect the device to look at the PDCCH to continue with normal RACH Access. The PDCCH will contain the new TA value to be used by the device.

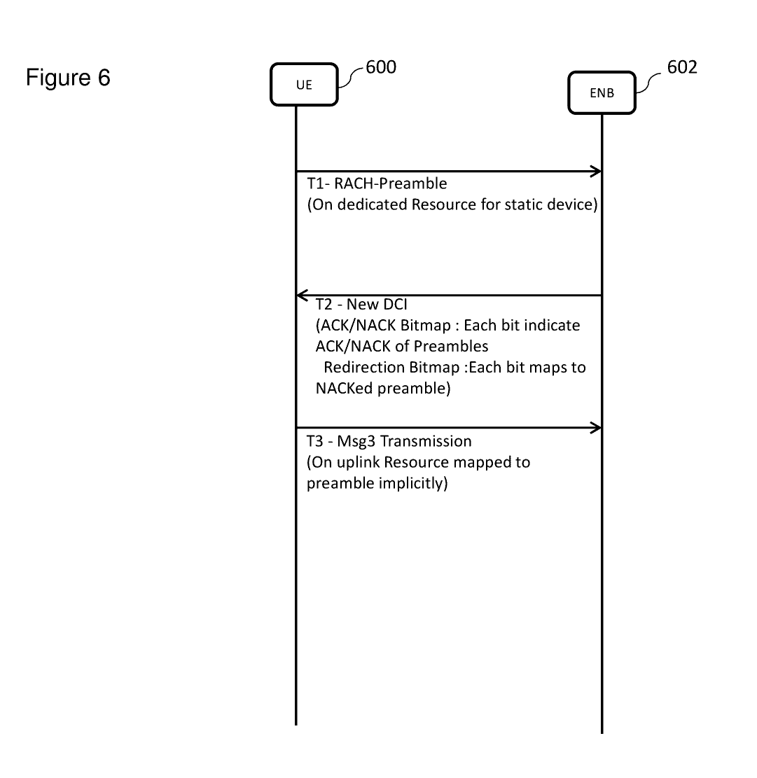

Reference is made to FIG. 6 which shows an embodiment.

In step T1, the device which has a preserved or stored timing advance value send its preamble on a dedicated resource. This dedicated resource may be for static devices. The preserved timing advance is thus used for RACH access.

In step T2, the eNodeB will estimate the timing of preamble and if it falls within the CP (cyclic prefix) duration, the current timing of the device can be used for uplink transmission. In such case, a DCI (downlink control information) acknowledging the received preamble is sent. The DCI will have an ACK. If the device receives an ACK in response to the sending of its preamble, the device can directly access the uplink resource which is implicitly mapped to the preamble. This mapping can be communicated via system information. When the preamble is ACKed, this means that the device can use the current timing advance itself. In this case it can directly use the uplink. The uplink resource allocation here is implicit. For each preamble identity, a specific uplink OFDM region is reserved for uplink access.

If the estimated timing indicates that the device timing needs to be adjusted (as it falls outside the CP duration) and communication of timing advance is required, the eNodeB include this preamble information in a redirection-bitmap. For this purpose a set of RA-RNTI (radio access RNTI) can be reserved. The eNodeB send the DCI using the reserved RA-RNTI. If device receives a NACK in the DCI, the device sends the preamble again using the same resources. If the device receives its preamble in redirection bitmap, the device will check the usual DCI in the RA-RNTI assigned for normal RACH Access to get its preamble, timing advance and uplink allocation information.

DCI-Downlink control information is sent in the PDCCH. This is the usual DCI. It provides information about DL/UL resource allocation. Some embodiments provide another DCI or provide further information in the usual DCI. This another DCI or further information will acknowledge the preamble and assign resources implicitly or provide the NACK.

In step T3, there is msg3 transmission from the device to the eNodeB. This is generally as described in relation to FIG. 4.

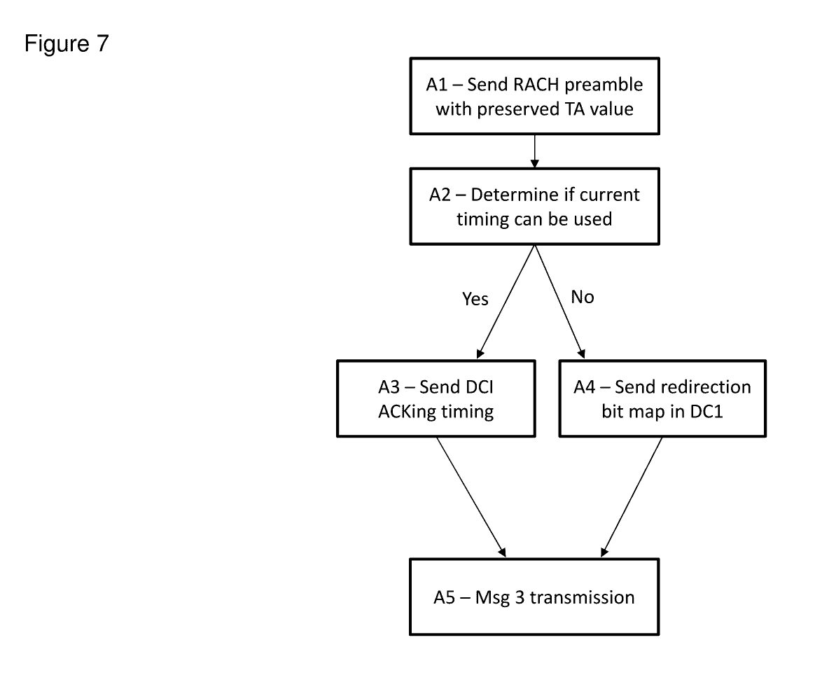

Reference is made to FIG. 7 which shows a method of an embodiment. In step A1, the device sends the RACH preamble with the stored or preserved TA value.

In step A2, at the eNodeB, control apparatus is configured to determine if the current TA timing can be used by the device in subsequent uplink communications.

If not, the next step is step A4 in which the control apparatus in the eNodeB is configured to provide a DCI with a NACK (in the PDCCH) to the device which directs the device to look into the PDDCH to continue with the normal RACH access.

If so, the next step is step A3 in which the control apparatus in the eNodeB is configured to provide an ACK in the DCI (in the PDCCH) which causes the device to continue to use the preserved TA value.

Steps A3 or A4 are followed by step A5 in which the devices sends an Msg3 transmission using the preserved TA value or the TA value obtained from information in the PDCCH.

In some embodiments, an eNodeB can acknowledge a group of devices using a single DCI which do not require timing advance to be communicated.

With individual RAR messages, such as in the known arrangements, when multiple RACH accesses are attempted, the eNodeB needs to schedule an independent RAR for each preamble or group separately. This impacts the RACH Procedure. This delay may be avoided in some embodiments.

For the device the overall procedure is reduced by one step as reception of RAR in downlink PDSCH is not required. In an extreme coverage condition case, this could reduce the RACH procedure by up to 216 ms. PDSCH transmission with 6 ms per M-Frame with 36 repetition will take 216 ms. With some embodiments PDSCH transmission and reception is skipped so up to 216 ms is saved. In general, the RACH procedure time may be reduced by reduced by N*TTI ms where N is the number of repetitions for extended coverage and TTI is TTI for single transmission. For 6 ms TTI and 36 rep it is 216. In other embodiments one or more the N and the TTI may have different values.

In some embodiments, the random access response may be retained. In the RAR, a bitmap or the like of preambles may be provided where each bit indicates the acknowledgement or not (e.g. ACK or NACK) of a respective preamble. A “1” may indicate the preamble has been received or vice versa. A “0” may indicate the preamble has not been received or vice versa. There may be a set of available preambles available to the devices (which may be a subset of all the available preambles or the full set of preambles). The device can start using the dedicated resource implicitly mapped to this acknowledged preamble using the current timing advance value. This may be without any further timing adjustments.

This ACK will indicate that this preamble can directly use the dedicated resource with current timing advance. For preambles for which explicit timing advance is needed, the current RAR contents will be used which assigns timing advance and uplink-resource for each preamble.

The eNodeB may communicate this mapping to the device via system information or there may be a method at the device to derive this resource based on selected preamble implicitly

In some embodiments the RAR message may be used to acknowledge more than one preamble where different preambles are used by different devices.

The eNodeB reserves and maps dedicated resources for each preamble for the above purpose. This mapping information may be provided to the device in any suitable manner such as via system information. Alternatively, a method may be performed at the device to derive the resource which is mapped to the selected preamble. This may be using any suitable algorithm. For example a hashing algorithm may be used.

It should be appreciated that embodiments may be used with any suitable standard. Some embodiments may be used with narrow band arrangement such as NB-LTE, LTE-M and NB-IoT. However, these are by way of example only and the some embodiments may be used in any other suitable scenario. Some embodiments may be used with non-narrow band scenarios.

In systems, devices can be in different coverage conditions. The coverage condition and corresponding repetition patterns may be represented by coverage class with some proposals. The embodiments have been described where the RACH access is being done in relatively poor network conditions. However, it should be appreciated that embodiments can be used in any type of network condition, good, bad and in-between.

Some embodiments may optimizes the RACH procedure from the device perspective and/or network resource perspective.

Some embodiments may be particularly useful for stationary devices. However, it should be appreciated that some embodiments may be used with moving devices. The moving devices may be relatively slow moving devices.

In some embodiments, information about the timing advance value may be sent with the RACH preamble instead of sending the preamble using the timing advance value to control the time at which the preamble is sent.

In some embodiments, a dedicated channel is provided for devices to send the RACH preamble.

Thus some embodiments may send a list of preambles with ACK/NACK in PDCCH itself, where ACK indicates that the device can use its current timing advance and directly access the PUSCH. NACK indicates that the device requires another RACH Access. Optionally, the PDCCH may itself carrying a timing advance for preamble is

Another variant is including an ACK/NACK bitmap for preambles in the RAR message itself. A “1” may mean that the corresponding preamble is received and the device's current TA can be used as such.

It should be understood that each block of the flowchart of the Figures and any combination thereof may be implemented by various means or their combinations, such as hardware, software, firmware, one or more processors and/or circuitry.

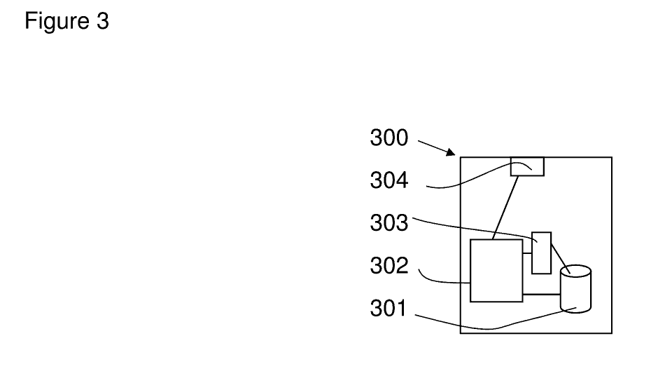

The method may be implemented on a communication device as described with respect to FIG. 2 or control apparatus as shown in FIG. 3. FIG. 3 shows an example of a control apparatus which is provided in the eNodeB. The control apparatus 300 comprises at least one memory 301, at least one data processing unit 302, 303 and an input/output interface 304. Via the interface the control apparatus can be coupled to a receiver and a transmitter of the base station. The receiver and/or the transmitter may be implemented as a radio front end or a remote radio head. For example the control apparatus 300 can be configured to execute an appropriate software code to provide the control functions.

It is noted that whilst embodiments have been described in relation to proposed LTE networks, similar principles maybe applied in relation to other networks and communication systems. Therefore, although certain embodiments were described above by way of example with reference to certain example architectures for wireless networks, technologies and standards, embodiments may be applied to any other suitable forms of communication systems than those illustrated and described herein.

It is also noted herein that while the above describes example embodiments, there are several variations and modifications which may be made to the disclosed solution without departing from the scope of the present invention.

In general, the various embodiments may be implemented in hardware or special purpose circuits, software, logic or any combination thereof. Some aspects of the invention may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the device or control apparatus, such as in the processor entity, or by hardware, or by a combination of software and hardware. Computer software or program, also called program product, including software routines, applets and/or macros, may be stored in any apparatus-readable data storage medium and they comprise program instructions to perform particular tasks.

A computer program product may comprise one or more computer-executable components which, when the program is run on a processor or the like, are configured to carry out embodiments. The one or more computer-executable components may be at least one software code or portions of it.

Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD. The physical media is a non-transitory media.

The memory may be of any type suitable to the local technical environment and may be implemented using any suitable data storage technology, such as semiconductor based memory devices, magnetic memory devices and systems, optical memory devices and systems, fixed memory and removable memory. The data processors may be of any type suitable to the local technical environment, and may comprise one or more of general purpose computers, special purpose computers, microprocessors, digital signal processors (DSPs), application specific integrated circuits (ASIC), FPGA, gate level circuits and processors based on multi core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The foregoing description has provided by way of non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims. Indeed there is a further embodiment comprising a combination of one or more embodiments with any of the other embodiments previously discussed.

1. A method comprising:
causing random access channel preamble information to be sent from a device to an access point, said random access channel preamble information being usable by said access point to determine first timing advance information; and
receiving in response to said random access channel preamble information, timing information indicating if said first timing advance information is to be used for transmissions from said device to said access point.

2. The method as recited in claim 1, wherein said timing information is in a control channel or a random access response.

3. The method as recited in claim 1, wherein said timing information is provided by a downlink control indication.

4. The method as recited in claim 1, wherein if said timing information indicates that said timing information is not to be used, the method comprises causing said device to use second timing advance information.

5. The method as recited in claim 1, wherein said timing information indicating that said timing information is not to be used comprises a negative acknowledgement and said timing information indicating that said timing information is to be used comprises an acknowledgement, and said acknowledgement causes said timing advance information to be used.

6. The method as recited in claim 1, wherein said random access channel preamble information comprises a random access channel preamble sent with a timing defined by the first timing advance information.

7. An apparatus comprising at least one processor and at least one memory including computer code for one or more programs, the at least one memory and the computer code configured, with the at least one processor, to cause the apparatus at least to:
cause random access channel preamble information to be sent from said apparatus to an access point, said random access channel preamble information being usable by said access point to determine first timing advance information; and
receive in response to said random access channel preamble information, timing information indicating if said first timing advance information is to be used for transmissions from said apparatus to said access point.

8. The apparatus as recited in claim 7, wherein said timing information is in a control channel or a random access response.

9. The apparatus as recited in claim 7, wherein said timing information is provided by a downlink control indication.

10. The apparatus as recited in claim 7, wherein if said timing information indicates that said timing information is not to be used, the method comprises causing said apparatus to use second timing advance information.

11. The apparatus as recited in claim 7, wherein said timing information indicating that said timing information is not to be used comprises a negative acknowledgement and said timing information indicating that said timing information is to be used comprises an acknowledgement, and said acknowledgement causes said timing advance information to be used.

12. The apparatus as recited in claim 7, wherein said random access channel preamble information comprises a random access channel preamble sent with a timing defined by the first timing advance information.

13. The apparatus as recited in claim 7, wherein said causing the random access preamble to be sent comprises sending said random access channel preamble information in a dedicated resource.

14. An apparatus comprising at least one processor and at least one memory including computer code for one or more programs, the at least one memory and the computer code configured, with the at least one processor, to cause the apparatus at least to:
receive random access channel preamble information from a device;
determine from said random access channel preamble information timing information indicating if first timing advance information is to be used for transmissions from said device to said apparatus; and
cause, in response to said random access channel preamble information, said timing information to be transmitted to said device.

15. The apparatus as recited in claim 14, wherein said timing information is in a control channel or a random access response.

16. The apparatus as recited in claim 14, wherein said timing information is provided by a downlink control indication.

17. The apparatus as recited in claim 14, wherein if said timing information indicates that said timing information is not to be used, the method comprises providing second timing advance information for said device.

18. The apparatus as recited in claim 14, wherein said timing information indicating that said timing information is not to be used comprises a negative acknowledgement and said timing information indicating that said timing information is to be used comprises an acknowledgement.

19. The apparatus as recited in claim 14, wherein said random access channel preamble information comprises a random access channel preamble sent with a timing defined by the timing advance information.

20. The apparatus as recited in claim 14, wherein said determining comprises determining if said timing of said preamble falls within a duration.
